(19) United States
(12) Patent Application Publication
(10) Pub. No.: US 2008/0136053 A1
(43) Pub. Date: Jun. 12, 2008

(54) COOLING APPARATUS FOR FIRED BODY, FIRING FURNACE, COOLING METHOD OF CERAMIC FIRED BODY, AND METHOD FOR MANUFACTURING HONEYCOMB STRUCTURE

(75) Inventors: Koji Kuribayashi, Ibi-gun (JP); Takamitsu Saijo, Dunavarsany (HU); Koji Higuchi, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/925,350

(22) Filed: Oct. 26, 2007

Related U.S. Application Data
(63) Continuation of application No. PCT/JP2006/304510, filed on Mar. 8, 2006.

(51) Int. Cl. B29C 47/00; F27D 15/02; F27D 3/00

(52) U.S. Cl. 264/177.12; 432/77; 432/239

(57) ABSTRACT

A cooling apparatus for a fired body includes a transporting member for transporting a firing jig in which a ceramic fired body is housed; a plurality of blowers for cooling the ceramic fired body; and a suction mechanism for changing the atmosphere inside the firing jig from an inert gas atmosphere to an air atmosphere.

### CROSS-REFERENCE TO RELATED APPLICATIONS

This application is a continuation application of PCT/JP2006/304510 filed on Mar. 8, 2006, entitled “COOLING APPARATUS FOR FIRED BODY, FIRING FURNACE, COOLING METHOD OF CERAMIC FIRED BODY, AND METHOD FOR MANUFACTURING HONEYCOMB STRUCTURE.” The contents of this application are incorporated herein by reference in their entirety.

### BACKGROUND OF THE INVENTION

1. Field of the Invention

The present invention relates to a cooling apparatus for a fired body, a firing furnace, a cooling method of a ceramic fired body, and a method for manufacturing a honeycomb structure.

2. Discussion of the Background

In recent years, particulates such as soot contained in exhaust gases that are discharged from internal combustion engines of vehicles, such as buses and trucks, and construction machines, have raised serious problems as contaminants harmful to the environment and the human body. There have been proposed various honeycomb filters using honeycomb structural bodies made from porous ceramic materials, which serve as filters that collect particulates in exhaust gases to purify the exhaust gases.

Conventionally, upon manufacturing such a honeycomb structure, first, a wet mixture is prepared by mixing ceramic powder, a binder and a dispersant solution or the like with one another. Moreover, the wet mixture is continuously extrusion-molded through a die, and the extrusion-molded body is cut into a predetermined length. Thus, a rectangular pillar-shaped honeycomb molded body is manufactured.

Next, the resulting honeycomb molded body is dried, and predetermined cells are sealed, so that either one of ends of each cell is sealed by the plug material layer.

The honeycomb molded body thus sealed is carried in a degreasing furnace so that degreasing is carried out thereon.

Next, the resulting honeycomb molded body that has been degreased is put into a firing furnace to carry out firing thereon, and this is then cooled to manufacture a honeycomb structure.

Thereafter, a sealing material paste is applied to the side faces of the honeycomb fired body, and the honeycomb fired bodies are mutually bonded, so that an aggregate of the honeycomb fired bodies in which a number of the honeycomb fired bodies are bound to one another by interposing the sealing material layers (adhesive layers) is manufactured. Next, the resulting aggregate of the honeycomb fired bodies is cut and machined into a predetermined shape, such as a cylindrical shape and a cylindroid shape, by using a cutting tool or the like, so that a honeycomb block is formed. Lastly, a sealing material paste is applied onto the periphery of the honeycomb block to form a sealing material layer (coat layer); thus, the manufacturing of the honeycomb structure is completed.

As described above, conventionally, the cooling of the honeycomb structures on which firing is carried out is conducted through natural radiation.

### SUMMARY OF THE INVENTION

A cooling apparatus for a fired body in accordance with a first aspect of the present invention includes a transporting member for transporting a firing jig in which a ceramic fired body is housed; a plurality of blowers for cooling the ceramic fired body; and a suction mechanism for changing the atmosphere inside the firing jig from an inert gas atmosphere to an air atmosphere.

In the cooling apparatus for a fired body in accordance with the first aspect of the present invention, the plurality of blowers are desirably placed at both sides with respect to the transporting member.

In the cooling apparatus for a fired body in accordance with the first aspect of the present invention, the suction mechanism is desirably placed at an upper side with respect to the transporting member.

The cooling apparatus for a fired body in accordance with the first aspect of the present invention desirably further includes a removing member for removing deposits adhering to the firing jig.

The cooling apparatus for a fired body in accordance with the first aspect of the present invention is desirably installed in a firing furnace, or next to a carrying-out port of a firing furnace.

A firing furnace in accordance with a second aspect of the present invention includes a transporting member for transporting a firing jig in which a ceramic molded body is housed from a carrying-in port toward a carrying-out port; a heating unit for heating the ceramic molded body; and the cooling apparatus for a fired body disclosed in the first aspect of the present invention, the cooling apparatus disposed such that a distance between the cooling apparatus and the carrying-out port is smaller than a distance between the heating unit and the carrying-out port.

In the firing furnace in accordance with the second aspect of the present invention, the plurality of blowers are desirably placed at both sides with respect to the transporting member in the cooling apparatus for a fired body.

A cooling method of a ceramic fired body in accordance with a third aspect of the present invention includes cooling a firing jig with a ceramic fired body housed in by using a cooling apparatus including a transporting member for transporting the firing jig, wherein the cooling apparatus further includes a plurality of blowers, and ceramic fired body which is housed inside the firing jig placed on the transporting member is cooled by the blowers.

In the cooling method of a ceramic fired body in accordance with the third aspect of the present invention, the ceramic fired body is desirably cooled to at least about 20° C. and at most about 80° C. in at least about 30 minutes and at most about 120 minutes.

In the cooling method of a ceramic fired body in accordance with the third aspect of the present invention, the cooling apparatus desirably further includes a suction mechanism for sucking the internal area of the cooling apparatus.

The suction mechanism is desirably placed at an upper side with respect to the transporting member.

In the cooling method of a ceramic fired body in accordance with the third aspect of the present invention, the plurality of blowers are desirably placed at both sides with respect to the transporting member.

In the cooling method of a ceramic fired body in accordance with the third aspect of the present invention, the blowers at one of the sides and the blowers at the other side are placed face to face with each other.

In the cooling method of a ceramic fired body in accordance with the third aspect of the present invention, the cooling apparatus desirably further includes a removing member for removing deposits adhering to the firing jig.

A method for manufacturing a honeycomb structure in accordance with a fourth aspect of the present invention includes manufacturing a pillar-shaped honeycomb molded body having a large number of cells longitudinally placed in parallel with one another with a cell wall therebetween, by molding a ceramic raw material; and firing the honeycomb molded body in a firing jig to manufacture a honeycomb structure such as a honeycomb fired body. The method further includes preparing a cooling apparatus having a transporting member for transporting the firing jig; and a plurality of blowers; and cooling the honeycomb fired body by using the cooling apparatus after the firing of the honeycomb molded body inside the firing jig.

In the method for manufacturing a honeycomb structure in accordance with the fourth aspect of the present invention, the cooling desirably cools the honeycomb fired body to at least about 20° C. and at most about 80° C. in at least about 30 minutes and at most about 120 minutes.

In the method for manufacturing a honeycomb structure in accordance with the fourth aspect of the present invention, the cooling apparatus desirably further includes a suction mechanism for sucking the internal area of the cooling apparatus.

The suction mechanism is desirably placed at an upper side with respect to the transporting member.

In the method for manufacturing a honeycomb structure in accordance with the fourth aspect of the present invention, the plurality of blowers are desirably placed at both sides with respect to the transporting member.

In the method for manufacturing a honeycomb structure in accordance with the fourth aspect of the present invention, the cooling apparatus desirably further includes a removing member for removing deposits adhering to the firing jig.

A method for manufacturing a honeycomb structure in accordance with a fifth aspect of the present invention includes manufacturing a pillar-shaped honeycomb molded body having a large number of cells longitudinally placed in parallel with one another with a cell wall therebetween, by molding a ceramic raw material; and firing the honeycomb molded body in a firing jig by using a firing furnace to manufacture a honeycomb structure such as a honeycomb fired body. The method further includes preparing a firing furnace including a cooling apparatus having a transporting member for transporting the firing jig, and a plurality of blowers; firing the honeycomb molded body in the firing jig to manufacture the honeycomb fired body; and cooling of the honeycomb fired body, the firing and the cooling are carried out in the firing furnace.

In the method for manufacturing a honeycomb structure in accordance with the fifth aspect of the present invention, the cooling desirably cools the honeycomb fired body to at least about 20° C. and at most about 80° C. in at least about 30 minutes and at most about 120 minutes.

In the method for manufacturing a honeycomb structure in accordance with the fifth aspect of the present invention, the cooling apparatus desirably further includes a suction mechanism for sucking the internal area of the cooling apparatus.

The suction mechanism is desirably placed at an upper side with respect to the transporting member.

In the method for manufacturing a honeycomb structure in accordance with the fifth aspect of the present invention, the plurality of blowers are desirably placed at both sides with respect to the transporting member.

In the method for manufacturing a honeycomb structure in accordance with the fifth aspect of the present invention, the cooling apparatus desirably further includes a removing member for removing deposits adhering to the firing jig.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view that schematically shows a cooling apparatus for a fired body in accordance with one embodiment of the first aspect of the present invention.

FIG. 2A is a cross-sectional view that shows a mode in which the cooling apparatus for a fired body in accordance with one embodiment of the first aspect of the present invention is installed next to a carrying-out port of a firing furnace. FIG. 2B is a cross-sectional view that shows a firing furnace in which the cooling apparatus for a fired body in accordance with one embodiment of the first aspect of the present invention is installed.

FIG. 3 is a perspective view that schematically shows one example of a honeycomb structure in accordance with one embodiment of the present invention.

FIG. 4A is a perspective view that schematically shows a honeycomb fired body that forms one component of the honeycomb structure in accordance with one embodiment of the present invention. FIG. 4B is a cross-sectional view taken along line A-A of FIG. 4A.

### DESCRIPTION OF THE EMBODIMENTS

The embodiments will now be described with reference to the accompanying drawings, wherein like reference numerals designate corresponding or identical elements throughout the various drawings.

The cooling apparatus for a fired body in accordance with the embodiment of the first aspect of the present invention includes: a transporting member for transporting a firing jig in which a ceramic fired body is housed; a plurality of blowers for cooling the ceramic fired body; and a suction mechanism for changing the atmosphere inside the firing jig from an inert gas atmosphere to an air atmosphere.

In the cooling apparatus for a fired body in accordance with the embodiment of the first aspect of the present invention, the ceramic fired body the temperature of which has been raised through the firing can be cooled in a short period of time without being influenced from the external temperature.

Moreover, since the ceramic fired body is cooled in its housed state inside the firing jig, the ceramic fired body can be indirectly cooled without being directly exposed to a cooling air flow from the blowers. Consequently, despite the fact that the ceramic fired body can be cooled in a shorter period of time in comparison with the conventional method, upon cooling the ceramic fired body, it becomes possible to prevent cracks and the like from occurring due to a thermal impact or the like.

The firing furnace in accordance with the embodiment of the second aspect of the present invention includes: a transporting member for transporting a firing jig in which a ceramic molded body is housed from a carrying-in port toward a carrying-out port; a heating unit for heating the ceramic molded body; and the cooling apparatus for a fired body in accordance with the embodiment of the first aspect of the present invention, which is disposed such that a distance between the cooling apparatus for a fired body and the carrying-out port is smaller than a distance between the heating unit and the carrying-out port.

In the firing furnace in accordance with the embodiment of the second aspect of the present invention, since the above-mentioned cooling apparatus for a fired body in accordance with the embodiment of the first aspect of the present invention is installed therein, the ceramic molded body can be of course fired, and the resulting ceramic fired body can be efficiently cooled in a short period of time.

The cooling method of a ceramic fired body in accordance with the embodiment of the third aspect of the present invention is a cooling method of a ceramic fired body in which a firing jig with a ceramic fired body housed in is cooled by using a cooling apparatus including a transporting member for transporting the firing jig. The cooling apparatus further includes a plurality of blowers, and ceramic fired body which is housed inside the firing jig placed on the transporting member is cooled by the blowers.

In the cooling method of a ceramic fired body in accordance with the embodiment of the third aspect of the present invention, since the ceramic fired body the temperature of which has been raised through the firing is cooled by using a predetermined cooling apparatus, the period of time required for the cooling can be shortened and the ceramic fired body can be cooled efficiently without being influenced from the external temperature.

Moreover, since the ceramic fired body is cooled in its housed state inside the firing jig, the ceramic fired body can be indirectly cooled without being directly exposed to a cooling air flow from the blowers. Consequently, despite the fact that the ceramic fired body can be cooled in a shorter period of time in comparison with conventional method, upon cooling the ceramic fired body, it becomes possible to prevent cracks and the like from occurring due to a thermal impact or the like.

The method for manufacturing a honeycomb structure in accordance with the embodiment of the fourth aspect of the present invention includes manufacturing a pillar-shaped honeycomb molded body having a large number of cells longitudinally placed in parallel with one another with a cell wall therebetween, by molding a ceramic raw material; firing the honeycomb molded body in a firing jig to manufacture a honeycomb structure such as a honeycomb fired body. The method further includes preparing a cooling apparatus having a transporting member for transporting the firing jig, and a plurality of blowers; and cooling the honeycomb fired body by using the cooling apparatus after the firing of the honeycomb molded body inside the firing jig.

In the present specification, the shape indicated by the word “pillar” refers to any desired shape of a pillar including a round pillar, an oval pillar, a polygonal pillar and the like.

In the method for manufacturing a honeycomb structure in accordance with the embodiment of the fourth aspect of the present invention, since the honeycomb fired body is cooled by using a predetermined cooling apparatus, the honeycomb fired body that has been fired and has a temperature rise can be cooled in a short period of time; therefore, it may become easier to improve the production efficiency of the honeycomb structure.

Moreover, upon cooling, the honeycomb fired body can be indirectly cooled without being directly exposed to a cooling air flow from the blowers. Consequently, despite the fact that the honeycomb fired body can be cooled in a shorter period of time in comparison with the conventional method, upon cooling the honeycomb fired body, it may become easier to prevent cracks and the like from occurring due to a thermal impact or the like, and consequently to ensure the quality of the honeycomb structure.

The method for manufacturing a honeycomb structure in accordance with the embodiment of the fifth aspect of the present invention includes manufacturing a pillar-shaped honeycomb molded body having a large number of cells longitudinally placed in parallel with one another with a cell wall therebetween, by molding a ceramic raw material; firing the honeycomb molded body in a firing jig by using a firing furnace to manufacture a honeycomb structure such as a honeycomb fired body. The method further includes preparing a firing furnace including a cooling apparatus having a transporting member for transporting the firing jig, and a plurality of blowers; and firing the honeycomb molded body in the firing jig to manufacture the honeycomb fired body; and cooling of the honeycomb fired body, the firing and the cooling carried out in the firing furnace.

In the method for manufacturing a honeycomb structure in accordance with the embodiment of the fifth aspect of the present invention, since the firing and the cooling are carried out by using a firing furnace provided with a predetermined cooling apparatus, the honeycomb fired body that has been fired and has a temperature rise can be cooled in a short period of time; therefore, it may become easier to improve the production efficiency of the honeycomb structure.

Moreover, during the cooling, the honeycomb fired body can be indirectly cooled without being directly exposed to a cooling air flow from the blowers. Consequently, despite the fact that the honeycomb fired body can be cooled in a shorter period of time in comparison with the conventional method, upon cooling the ceramic fired body, it may become easier to prevent cracks and the like from occurring due to a thermal impact or the like, and consequently to ensure the quality of the honeycomb structure.

First, referring to the drawings, the following description will discuss a cooling apparatus for a fired body in accordance with the embodiment of the first aspect of the present invention, a firing furnace in accordance with the embodiment of the second aspect of the present invention and a cooling method of a ceramic fired body in accordance with the embodiment of the third aspect of the present invention.

Here, in the embodiments of the first to third aspects of the present invention, a ceramic fired body to be cooled may be any fired body as long as it is obtained by firing a ceramic molded body. With respect to the ceramic fired body, for example, the honeycomb fired body and the like may be used.

Here, the firing furnace in accordance with the embodiment of the second aspect of the present invention is provided with the cooling apparatus for a fired body in accordance with the embodiment of the first aspect of the present invention. Moreover, the cooling method of a ceramic fired body in accordance with the embodiment of the third aspect of the present invention is desirably carried out by using the cooling apparatus for a fired body in accordance with the embodiment of the first aspect of the present invention.

Therefore, the following description will first discuss the cooling apparatus for a fired body in accordance with the embodiment of the first aspect of the present invention, next discuss the firing furnace in accordance with the embodiment of the second aspect of the present invention that is provided with the cooling apparatus for a fired body, and then discuss the cooling method of the ceramic fired body in accordance with the embodiment of the third aspect of the present invention.

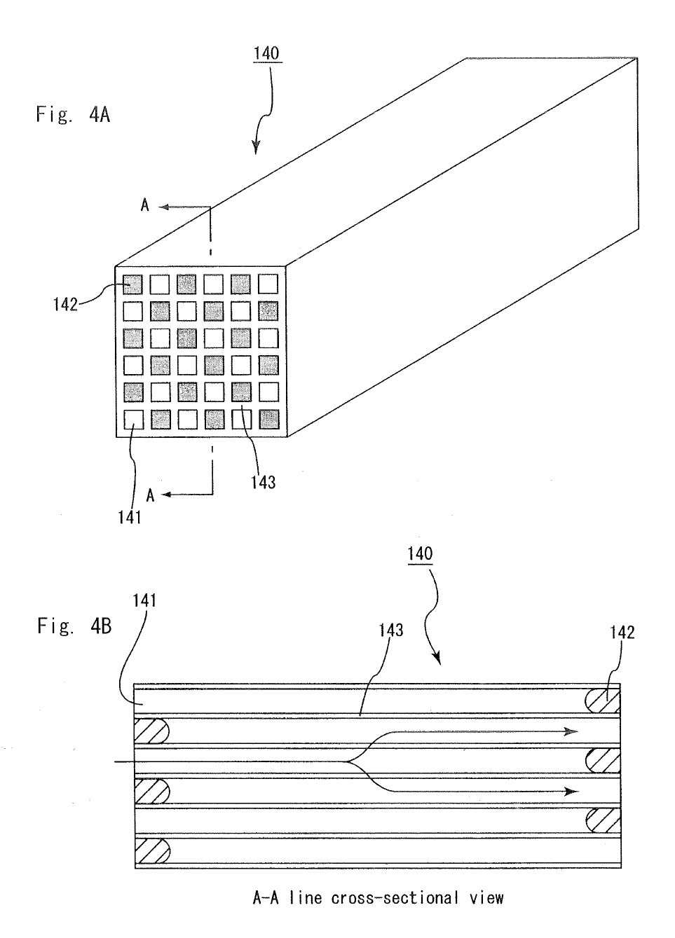

Moreover, the embodiments of the first to third aspects of the present invention will be discussed by exemplifying a honeycomb fired body shown in FIGS. 4A and 4B as the ceramic fired body to be cooled. Of course, the ceramic fired body to be cooled in accordance with the embodiments of the first to third aspects of the present invention is not limited to the honeycomb fired body, and various ceramic fired bodies may be used as the subject to be cooled.

Here, in the present specification, in any of modes of the honeycomb molded body, the honeycomb fired body and the honeycomb structure, among the faces forming the respective external shapes, those faces to which cells are exposed are referred to as end faces, and those faces other than the end faces are referred to as side faces.

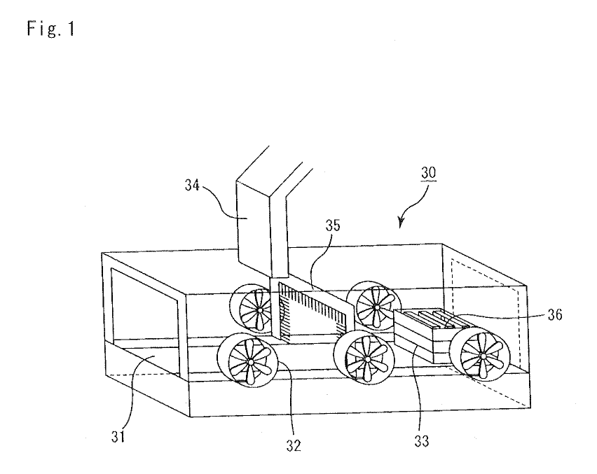

FIG. 1 is a perspective view that schematically shows a cooling apparatus for a fired body in accordance with one embodiment of the first aspect of the present invention. As shown in FIG. 1, a cooling apparatus 30 for a fired body is provided with a transporting member 31 for transporting a firing jig 33 in which a honeycomb fired body 36 is housed, a plurality of blowers 32 that are placed at both sides with respect to the transporting member 31, and used for cooling the honeycomb fired body 36, and a suction mechanism 34, placed at the upper side with respect to the transporting member 31, which changes the atmosphere inside the firing jig 33 from an inert gas atmosphere to an air atmosphere. Here, a removing member 35, for removing deposits adhering to the firing jig 33 in a firing, is attached in a manner so as to enclose the firing jig 33 that has been transported.

With respect to the transporting member 31, not particularly limited as long as it allows the firing jig 33 to be smoothly transported, and for example, a conveyor, such as a belt conveyor and a chain conveyor, a transporting device of a walking beam type and the like may be used.

In the cooling apparatus 30 for a fired body, the honeycomb fired body 36 inside the firing jig 33 carried out from a firing furnace is transported by the transporting member 31 from a carrying-in port in its housed state inside the firing jig 33, and cooled by the blowers 32 placed at both sides with respect to the transporting member 31, and then carried out from a carrying-out port. In this case, the honeycomb fired body 36 is maintained in the housed state inside the firing jig 33, with the result that the honeycomb fired body 36 is not directly exposed to a cooling air flow from the blowers 32. In this manner, since the honeycomb fired body 36 is not locally cooled, it may become easier to reduce a thermal impact or the like imposed on the honeycomb fired body 36, and consequently to prevent cracks and the like from occurring in the honeycomb fired body 36.

Here, for convenience of explanation, the honeycomb fired body 36 is illustrated in an exposed state in the firing jig 33 shown in FIG. 1; however, a roof plate is normally mounted on the uppermost portion of the firing jig 33, and the honeycomb fired body 36 is housed in the firing jig 33 in a non-exposed state.

Here, since the inside of the cooling apparatus 30 for a fired body is under a negative pressure (reduced pressure) by the suction mechanism 34, and is also kept in an air atmosphere, as will be described later, the honeycomb fired body 36 is cooled, and in the case where the atmosphere inside the firing jig 33 is an inert gas atmosphere, this inert gas atmosphere can be changed into an air atmosphere.

When the firing jig 33 has been transported to the position of the removing member 35 having a brush or the like, the brush or the like of the removing member 35 removes deposits adhering to the surface of the firing jig 33 through its reciprocating movements, rotation movements or the like. The deposits, thus removed by the removing member 35, are sucked by the suction mechanism 34 attached to a position closer to the carrying-out port than the position where the removing member 35 is installed, and collected outside the cooling apparatus 30 for a fired body together with the inert gas. Here, the attached position of the removing member 35 is not particularly limited, as will be described later.

Thereafter, the firing jig 33 from which the deposits have been removed is transported through a carrying-out port, and transported to the next process. At this time, since the honeycomb fired body 36 has been cooled to a sufficiently low temperature that may make it easier to allow the succeeding treatment or inspection, the honeycomb fired body 36 can be directly sent to the next process without the necessity of a waiting process; thus, it may become easier to improve the working efficiency.

Here, the firing jig 33, which is used upon firing a honeycomb molded body (ceramic molded body), is a firing jig made from a ceramic material, which can be used in a superposed state with a number of stages. The firing jig 33 may be provided with a vent portion at its one portion so as to allow ventilation between a space surrounded by the firing jig 33 and the outside, when superposed. Therefore, during the firing and the cooling, the firing jigs 33, each housing a honeycomb molded body (ceramic molded body), are superposed in multiple stages, and firing is carried out thereon; thus, the resulting honeycomb fired body 36 can be cooled by the cooling apparatus 30 for a fired body.

With respect to the blower 32, its structure is not particularly limited as long as a convection of an atmospheric gas can be raised inside the firing jig 33, and a structure for sending air by rotating blades at high speeds or a structure for sending air by applying a pressure to the atmospheric gas may be used. Moreover, the blower 32 may send a cooling air flow having the same temperature as the temperature of the inside of the cooling apparatus 30 for a fired body, or a cooling air flow having a different temperature. The temperature of cooling air flows to be sent from the blowers 32 can be appropriately changed by taking into consideration the properties of the honeycomb fired body 36, working efficiency and the like.

Here, the suction mechanism 34 is being operated during at least the time when cooling in which the honeycomb fired body 36 is cooled by operating the cooling apparatus 30 for a fired body is carried out, so that air, warmed up by the honeycomb fired body is continuously or regularly sucked. For this reason, it may become easier to cool the honeycomb fired body quickly.

Moreover, by operating the suction mechanism 34, the atmosphere inside the firing jig 33 tends to be changed into an air atmosphere.

The atmosphere inside the firing furnace is normally substituted by an inert gas atmosphere so as to suppress undesired reactions upon firing the honeycomb molded body (ceramic molded body), and in addition to the substituted atmosphere inside the firing furnace, the inside of the firing jig 33 is of course substituted by an inert gas atmosphere. When, upon cooling, the inside of the firing jig 33 is in an inert gas atmosphere, the inert gas atmosphere inside the firing jig 33 tends to be changed into an air atmosphere by operating the suction mechanism 34.

Moreover, the cooling apparatus 30 for a fired body is provided with an air intake (not shown) for taking in clean air from outside, and can continuously take in clean air such as filtered air. Therefore, the inside of the cooling apparatus 30 for a fired body is maintained in an air atmosphere.

In the cooling apparatus for a fired body in accordance with the embodiment of the first aspect of the present invention, the blowers are desirably placed at both sides with respect to the transporting member.

As shown in FIG. 1, in the case where the blowers 32 are placed at both sides with respect to the transporting member 31, since the cooling air flow tends to be uniformly applied to the firing jig 33, the firing jig 33 tends to be cooled equally so that the honeycomb fired body 36 housed in the firing jig 33 also can be cooled uniformly.

In this case, with respect to the blowers 32 placed at one of the sides of the transporting member 31 and at the other side of the transporting member 31, the numbers thereof may be the same or different from each other, as long as the honeycomb fired body 36 can be uniformly cooled.

Moreover, the installation intervals of the blowers 32 may be equal to or different from each other; however, from the viewpoint of a uniform cooling for the firing jig 33 (honeycomb fired body 36), the equal installation interval is more desirable.

With respect to the relative positions between the blowers at one of the sides and those at the other side, those may be placed face to face with each other, or may be placed alternately, as long as the honeycomb fired body 36 can be uniformly cooled. From the viewpoint of the cooling efficiency, those are desirably placed alternately.

In the cooling apparatus for a fired body in accordance with the embodiment of the first aspect of the present invention, the suction mechanism is desirably placed at the upper side with respect to the transporting member.

When deposits, dusts and the like, removed by the removing member 35, are scattered by air directed from the blowers 32, this arrangement tends not to allow the deposits, dusts and the like to again adhere to the transporting member 31 and the firing jig 33, and can allow the deposits, dusts and the like to be properly sucked and externally discharged.

Moreover, when a plurality of blowers are placed at both sides with respect to the transporting member, air, sent from the blowers, is heated due to heat obtained upon cooling the firing jig, and directed upward. When the suction mechanism is placed at the upper side with respect to the transporting member, the air that has been heated and directed upward tends to be efficiently sucked so that an inert gas, deposits, dusts and the like tends to be efficiently sucked. In this manner, the suction mechanism 34 is also allowed to function as a dust collector.

Specifications such as a suction pressure and shape of the suction mechanism 34 can be properly altered by taking into consideration the ventilation capability, installation spaces and the like required for exchanging atmospheric gases. With respect to the shape of the suction mechanism 34, as shown in FIG. 1, a shape in which a suction port is formed only on one portion of the upper face of the cooling apparatus 30 for a fired body may be used, or a flange shape in which the entire upper face serves as a suction port, with the diameter of the suction port being gradually narrowed, may be used.

The cooling apparatus for a fired body in accordance with the embodiment of the first aspect of the present invention is desirably provided with a removing member for removing deposits adhering to the firing jig, as indicated in the cooling apparatus 30 for a fired body shown in FIG. 1.

When a firing jig to which deposits have adhered during the firing, as it is, is used in a new firing, the honeycomb fired body (ceramic fired body) tends to be adversely affected due to evaporation or the like of the deposits; however, when the removing member 35 is prepared, the deposits adhering to the firing jig 33 tends to be removed so that even when the firing jig 33 is used in the next firing, no adverse effects tends to be given to the firing of the honeycomb molded body (ceramic molded body) so that the firing jig 33 can be used repeatedly without the necessity of carrying out the removing of the deposits separately. Therefore, the firing jig can be used repeatedly without the necessity of overlapped maintenance.

Here, the number of the removing members 35 is not particularly limited as long as a sufficient space is available in the cooling apparatus 30 for a fired body, and can be determined on demand.

With respect to the removing member, not particularly limited as long as it can remove deposits adhering to the firing jig, a brush as shown in FIG. 1 may be used, or a curtain-shaped member may be used. Moreover, the removing member is desirably designed to be made in contact with the upper face and side faces of the firing jig as shown in FIG. 1; however, it may be designed to be made in contact with only the upper face or only the side faces of the firing jig.

With respect to the material for the removing member, examples thereof include: resin, cloth and leather.

Moreover, the removing member may be prepared as a fixed member as shown in FIG. 1, or may have a mode in which it is driven through vibration, reciprocating movement, rotating movement or the like to remove the deposits.

With respect to the installation position of the removing member 35, not particularly limited, it may be installed at a position closer to the carrying-in port than the position where the suction mechanism 34 is installed or, in contrast, may be installed at a position closer to the carrying-out port than the position where the suction mechanism 34 is installed. Moreover, it may be installed right below the suction mechanism 34. In either of the cases, the deposits can be efficiently removed by the removing member 35.

The removing member is desirably attached to the vicinity of the suction mechanism. This arrangement tends to allow the deposits removed by the removing member to be sucked without being scattered, making it possible to maintain the inside of the cooling apparatus for a fired body in a clean state.

The cooling apparatus for a fired body in accordance with the embodiment of the first aspect of the present invention is desirably installed next to the carrying-out port of the firing furnace. When the cooling apparatus for a fired body is installed next to the carrying-out port of the firing furnace, the honeycomb fired body (ceramic fired body) can be cooled efficiently.

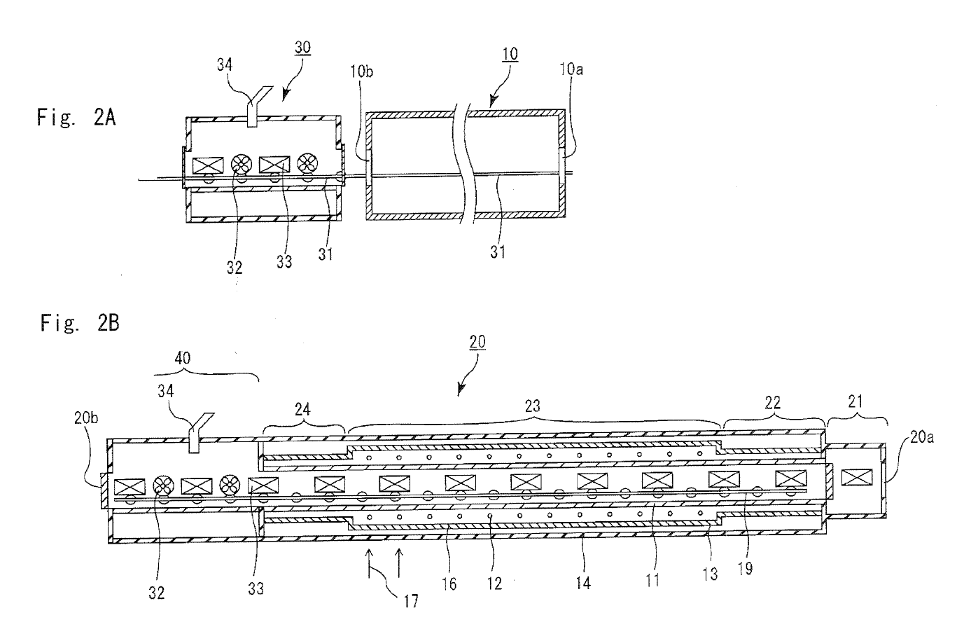

FIG. 2A is a cross-sectional view that shows a mode in which the cooling apparatus for a fired body in accordance with one embodiment of the first aspect of the present invention is installed next to the carrying-out port of the firing furnace.

In the mode shown in FIG. 2A, the cooling apparatus 30 for a fired body is installed next to a carrying-out port 10b of the firing furnace 10. Here, although omitted from the illustration, the firing furnace 10 is a continuous furnace, and the honeycomb molded body, transported through a carrying-in port 10a, is fired in the furnace, and then carried out through the carrying-out port 10b as a honeycomb fired body. The honeycomb fired body, thus transported through the carrying-out port 10b, is then successively transported into the cooling apparatus 30 for a fired body where it is cooled by the blowers 32 as described earlier.

Moreover, in the mode shown in FIG. 2A, a continuous single transporting member 31 is used as a transporting member for transporting the honeycomb fired body through the cooling apparatus 30 for a fired body and as a transporting member for transporting the honeycomb molded body through the firing furnace 10; however, in this case, the transporting member is not necessarily prepared as the continuous single transporting member, and another structure may be used in which respectively different transporting members are used in the firing furnace and in the cooling apparatus for a fired body so that after the carrying-out from the firing furnace is carried out, the transporting members are switched to support the firing jig 33 before the carrying-in to the cooling apparatus for a fired body.

Moreover, the firing furnace next to which the cooling apparatus for a fired body is installed is not limited to a continuous furnace as shown in FIG. 2A, and may be prepared as a batch furnace.

Furthermore, the cooling apparatus for a fired body in accordance with the embodiment of the first aspect of the present invention is also desirably installed inside the firing furnace.

FIG. 2B is a cross-sectional view that shows the firing furnace in which the cooling apparatus for a fired body in accordance with the embodiment of the first aspect of the present invention is installed.

When the cooling apparatus for a fired body is installed inside the firing furnace, the honeycomb fired body (ceramic fired body) can be cooled efficiently.

In addition, in the case where the cooling apparatus for a fired body is provided with the suction mechanism, since an inert gas atmosphere tends to be changed into an air atmosphere, the cooling apparatus for a fired body is allowed to function as both of a cooling unit and a degassing unit in the conventional firing furnace, therefore, it may become easier to save the space in the firing furnace and consequently to provide a further efficient method.

As shown in FIG. 2B, from the carrying-in port 20a to the carrying-out port 20b inside the firing furnace 20, a degassing unit 21, a pre-heating unit 22, a heating unit 23, an cooling-down unit 24 and the cooling apparatus 40 for a fired body are successively installed.

Here, the structure of the cooling apparatus 40 for a fired body is the same as described earlier; therefore, the description thereof is omitted.

The heating unit 23 has a structure in which a cylinder-shaped muffle 11 is formed so as to ensure a space through which the firing jig 33 housing the molded body therein can pass. Here, heaters 12 are installed above and below the muffle 11 with predetermined intervals, and a heat-insulating layer 13 is formed in a manner so as to surround the muffle 11 and the heater 12. Moreover, a heat-insulating layer attaching member 16 for attaching the heat-insulating layer 13 is placed outside the heat-insulating layer 13, and a furnace-cooling member (water-cooling jacket) 14 is installed outside the heat-insulating layer attaching member 16, that is, on the outermost surface of the firing furnace 20.

The atmosphere inside the firing furnace 20 (inside of the pre-heating unit 22, the heating unit 23 and the cooling-down unit 24) is exchanged by an inert gas atmosphere by an inert gas 17 introduced from the outside, and isolated from the ambient atmosphere by the furnace cooling member 14. A cooling fluid, such as water, is allowed to flow the inside of the cooling furnace member 14 so that the cooling furnace member 14 is maintained at a predetermined temperature.

The atmosphere of the inside of the firing furnace 20 may be set to a predetermined atmosphere depending on the kind of a ceramic molded body.

In the firing furnace 20, the heaters 12 are installed above and below the muffle 11; however, the installation position of the heaters is not limited to this, and the heaters 12 may be installed at any place as long as they are on the peripheral portion of the muffle 11. The entire floor portion of the muffle 11 is supported by a supporting member, not shown, and the firing jig 33 housing the honeycomb molded body (ceramic molded body) therein can be allowed to pass through it. The muffle 11 is placed over the entire portion of the firing furnace 20 except for the degassing unit 21 and the cooling apparatus 40 for a fired body.

Each heater 12 is a heat generating member made of graphite or the like, and the heater 12 is connected to a power supply (not shown) located outside through a terminal. The heaters 12 are installed in the heating unit 23, and are also installed in the pre-heating unit 22, if necessary.

The heat-insulating layers 13, which block heat generated from the heating unit 23 and heat transmitted from the heating unit 23, are placed on the pre-heating unit 22, the heating unit 23 and the cooling-down unit 24. In the heating unit 23, the heat-insulating layer 13 is placed so as to surround the heater 12, and the heat-insulating layer 13 is attached and secured to the heat-insulating layer attaching member 16 installed right outside thereof. Moreover, the cooling furnace member 14 is placed over the entire area except for the degassing unit 21 on the outermost side.

The degassing unit 21 is installed so as to change the atmosphere of the inside and peripheral portion of the firing jig 43 to be carried in into an inert gas atmosphere for use in firing. With respect to the sequence of processes for exchanging the atmosphere in the degassing unit 21, after the firing jig 33 mounted on the supporting base has been carried in, the degassing unit 21 is once evacuated, and an inert gas is then directed thereto so that the atmosphere of the inside and periphery of the firing jig 43 is changed into an inert gas atmosphere.

After the atmosphere inside the firing jig 43 has been changed by the degassing unit 21, the pre-heating unit 22 gradually raises the temperature of the firing jig 33 in which the honeycomb molded body (ceramic molded body) is housed by using the attached heaters, or by utilizing the heat of the heating unit.

Next, the firing jig 33 is transported to the heating unit 23 by the transporting device 19, and firing is carried out on the honeycomb molded body in the heating unit 23. Upon completion of the firing of the honeycomb molded body, the firing jig 43 after the firing is gradually cooled in the cooling-down unit 24.

The firing jig 43 is transported to the cooling apparatus 40 for a fired body installed inside the firing furnace 20 so that the temperature of the firing jig 43 is lowered to a predetermined temperature by using a plurality of blowers 32 installed in the cooling apparatus 40 for a fired body.

In the cooling apparatus 40 for a fired body, while the firing jig 43 is cooled to the predetermined temperature, deposits adhering to the firing jig 43 are removed by a removing member 35 installed on demand, and the atmosphere inside the firing jig 43 is exchanged from an inert gas atmosphere to an air atmosphere by using a suction mechanism (not shown) attached at the upper side with respect to the transporting device or the transporting member, and the firing jig 43 is carried out through the carrying-out port 20b; thus, the firing are completed.

Here, in the firing furnace 20, the cooling apparatus 40 for a fired body is disposed such that a distance between the cooling apparatus 40 for a fired body and the carrying-out port 20b is smaller than a distance between the heating unit 23 and the carrying-out port 20b. In the firing furnace 20, the cooling apparatus 40 for a fired body is placed at any position as long as it is located at least behind the heating unit 23, when viewed in the transporting direction of the transporting device 19.

In this manner, even in the case where the cooling apparatus 40 for a fired body is installed inside the firing furnace 20, since the suction mechanism for use in exchanging the atmosphere is prepared in the cooling apparatus 40 for a fired body, the atmosphere inside the firing jig 43 tends to be exchanged to an air atmosphere without the necessity of separately installing a degassing unit or the like in the firing furnace 20.

Moreover, in the case where the cooling apparatus 40 for a fired body is installed inside the firing furnace 20, in place of the transporting member 31 (see FIG. 1) forming the cooling apparatus 40 for a fired body, a transporting device 19 forming the firing furnace 20 may be extended into the cooling apparatus 40 for a fired body so that the firing jig 33 is transported, or the transporting member 31 and the transporting device 19 may be combined so as to carry out the transporting.

The above description has discussed in detail a mode in which the cooling apparatus for a fired body in accordance with the embodiment of the first aspect of the present invention is installed inside the firing furnace, and the firing furnace of this kind in which the cooling apparatus for a fired body is installed is also one of the embodiments (firing furnace in accordance with the embodiment of the second aspect of the present invention) of the present invention.

In the firing furnace in accordance with the embodiment of the second aspect of the present invention, since no transporting of a honeycomb fired body (ceramic fired body) is separately prepared between the firing and the cooling of the honeycomb fired body (ceramic fired body), the firing and cooling can be continuously carried out so that the all the processes including the firing and the cooling tend to be efficiently carried out.

The following description will discuss a cooling method of a ceramic fired body in accordance with the embodiment of the third aspect of the present invention.

In the cooling method of a ceramic fired body in accordance with the embodiment of the third aspect of the present invention, a ceramic fired body, housed in a firing jig, is cooled by using a cooling apparatus provided with a plurality of blowers.

The cooling apparatus to be used in the cooling method of a ceramic fired body in accordance with the embodiment of the third aspect of the present invention is only required to include a transporting member and a plurality of blowers, and its structure is not particularly limited. With respect to the transporting member and the blowers, those transporting member and blowers used in the cooling apparatus for a fired body in accordance with the embodiment of the first aspect of the present invention are desirably used.

With respect to the embodiment of the cooling apparatus having such a structure, more specifically, a structure in which no suction mechanism is attached to the cooling apparatus for a fired body in accordance with the embodiment of the first aspect of the present invention that has been explained by reference to FIG. 1 is proposed. Of course, the cooling apparatus to be used in the cooling method in accordance with the embodiment of the third aspect of the present invention may be provided with a suction mechanism.

Since the structure of the above-mentioned cooling apparatus has been described in detail in the explanation of the cooling apparatus for a fired body in accordance with the embodiment of the first aspect of the present invention, the description thereof is omitted, and the following description will mainly discuss cooling conditions and the like in accordance with the cooling method of a ceramic fired body in accordance with the embodiment of the third aspect of the present invention.

In the cooling method of a ceramic fired body in accordance with the embodiment of the third aspect of the present invention, the honeycomb fired body (ceramic fired body) is desirably cooled to at least about 20° C. and at most about 80° C. in at least about 30 minutes and at most about 120 minutes.

The temperature of the honeycomb fired body (ceramic fired body) that has been fired and transported through the cooling-down unit is at least about 280° C. and at most about 300° C., and the cooling is carried out from this temperature range, under predetermined cooling conditions. In the case where the cooling time required to cool the honeycomb fired body (ceramic fired body) to about 20° C. becomes about 30 minutes or more, the honeycomb fired body (ceramic fired body) tends to withstand a thermal impact caused upon cooling, therefore, damages such as cracks tend not to occur. In contrast, in the case where the cooling time required to cool to about 80° C. is about 120 minutes or less, the cooling efficiency can be improved. By adopting the above-mentioned cooling conditions, it becomes possible to efficiently cool the honeycomb fired body (ceramic fired body), while preventing the occurrence of cracks and the like.

In the embodiment of the third aspect of the present invention, the flow rate from the blowers installed in the cooling apparatus may be appropriately changed in accordance with the number of honeycomb fired bodies (ceramic fired bodies) to be cooled and the shape and the like of the firing jig, and, for example, the flow rate of at least about 10000 m³/h and at most about 40000 m³/h can be adopted. With this flow rate range, it becomes possible to carry out an efficient cooling operation while preventing the occurrence of cracks or the like in the honeycomb fired body (ceramic fired body).

In the embodiment of the third aspect of the present invention, the temperature inside the cooling apparatus is desirably set in at least about 15° C. and at most about 30° C. With this temperature range, it becomes possible to carry out an efficient cooling operation while preventing the occurrence of cracks or the like in the honeycomb fired body (ceramic fired body).

Moreover, the cooling apparatus to be used in the embodiment of the third aspect of the present invention is desirably provided with a suction mechanism for sucking the internal area of the cooling apparatus. With respect to this cooling apparatus provided with the suction mechanism, the cooling apparatus for a fired body in accordance with the embodiment of the first aspect of the present invention is desirably adopted.

The blowers are desirably placed at both sides with respect to the transporting member, and the cooling apparatus is also desirably provided with a removing member for removing deposits adhering to the firing jig. The reasons for these arrangements are the same as those explained in the cooling apparatus for a fired body in accordance with the embodiment of the first aspect of the present invention.

For example, in the case where the suction mechanism is made of a pillar-shaped pipe of about 60 cm×about 60 cm, although not particularly limited, the suction speed during the sucking by the suction mechanism is desirably set to at least about 5 m/s and at most about 10 m/s inside the pipe. When the suction speed is set in the above-mentioned range, it may become easier to efficiently exchange the atmosphere inside the firing jig and to effectively suck the exchanged inert gas and deposits.

With respect to the firing jig, the firing jig used in the cooling apparatus for a fired body in accordance with the embodiment of the first aspect of the present invention is desirably used. With respect to the number of stages of the superposed firing jigs, not particularly limited, one stage or a multiple superposed stages may be used. In particular, when at least 5 superposed stages and at most 15 superposed stages are used, it may become easier to improve the processing efficiency by using the multiple superposed stages, while preventing the cooling of the honeycomb fired body (ceramic fired body) from becoming insufficient.

Here, although not particularly limited, the number of honeycomb fired bodies (ceramic fired bodies) to be housed in one firing jig is desirably set to at least 7 and at most 20,when the cooling efficiency is taken into consideration.

As described above, in the cooling method for a ceramic fired body in accordance with the embodiment of the third aspect of the present invention, it becomes possible to efficiently carry out cooling, while preventing the occurrence of cracks and the like in a honeycomb fired body (ceramic fired body).

The following description will discuss a method for manufacturing a honeycomb structure in accordance with the embodiment of the fourth aspect of the present invention.

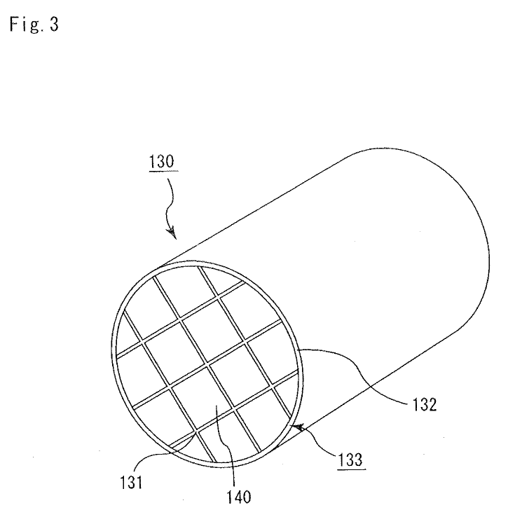

FIG. 3 is a perspective view that schematically shows one example of a honeycomb structure in accordance with one embodiment of the present invention. FIG. 4A is a perspective view that schematically shows a honeycomb fired body that forms one component of the honeycomb structure in accordance with one embodiment of the present invention. FIG. 4B is a cross-sectional view taken along line A-A of FIG. 4A.

In the honeycomb structure 130, a plurality of honeycomb fired bodies 140 shown in FIGS. 4A and 4B are bound to one another by interposing sealing material layers (adhesive layers) 131 to form a honeycomb block 133, and a sealing material layer (coat layer) 132 is further formed on the periphery of this honeycomb block 133.

Moreover, as shown in FIGS. 4A and 4B, the honeycomb fired body 140 has a large number of cells 141 longitudinally placed in parallel with one another, and each cell wall 143 that separates the cells 141 is allowed to function as a filter.

In other words, as shown in FIG. 4B, each of the cells 141, formed in the honeycomb fired body 140, is sealed with a plug material layer 142 at either one of ends on its exhaust gas inlet side and exhaust gas outlet side, so that exhaust gases that have entered one cell 141 are discharged from another cell 141 after having always passed through each cell wall 143 that separates the cells 141. When exhaust gases pass through the cell wall 143, particulates are captured by the cell wall 143, so that the exhaust gases are purified.

Here, the following description will discuss the method for manufacturing a honeycomb structure in accordance with the embodiment of the fourth aspect of the present invention in which powder of silicon carbide that is a ceramic raw material is used, by exemplifying manufacturing of a honeycomb structure which is mainly composed of silicon carbide as a constituent material.

Of course, the main component of constituent materials for the honeycomb structure is not intended to be limited by silicon carbide, and, other examples thereof include: nitride ceramic materials, such as aluminum nitride, silicon nitride, boron nitride and titanium nitride, carbide ceramic materials, such as zirconium carbide, titanium carbide, tantalum carbide and tungsten carbide, oxide ceramic materials, such as alumina, zirconia, cordierite, mullite, and aluminum titanate, and the like.

Among these, non-oxide ceramic materials are desirably used, and in particular, silicon carbide is more desirably used. Silicon carbide is used because of its superior heat resistant property, mechanical strength, thermal conductivity and the like. Here, materials, such as a silicon-containing ceramic material formed by blending metal silicon in the above-mentioned ceramic material and a ceramic material that is combined by silicon or a silicate compound, may also be used as the constituent materials, and among these, a material in which metal silicon is blended in silicon carbide (silicon-containing silicon carbide) is desirably used.

First, inorganic powder, such as silicon carbide powders having different average particle diameters, and an organic binder are dry-mixed to prepare mixed powder, and a liquid-state plasticizer, a lubricant and water are mixed to prepare a mixed liquid, and the mixed powder and the mixed liquid are mixed by using a wet-mixing device so that a wet mixture for use in manufacturing a molded body is prepared.

With respect to the particle diameter of silicon carbide powder, although not particularly limited, the silicon carbide powder which tends not to cause the case where the size of the honeycomb structure manufactured by the following firing treatment becomes smaller than that of the degreased honeycomb molded body is desirable, and for example, mixed powder, prepared by combining 100 parts by weight of powder having an average particle diameter of at least about 0.3 μm and at most about 50 μm with at least about 5 parts by weight and at most about 65 parts by weight of powder having an average particle diameter of at least about 0.1 μm and at most about 1.0 μm, is desirably used.

In order to adjust the pore diameter and the like of the honeycomb fired body, it is necessary to adjust the firing temperature, and the pore diameter can be adjusted by adjusting the particle diameter of the inorganic powder.

With respect to the above-mentioned organic binder, not particularly limited, examples thereof include: methylcellulose, carboxymethyl cellulose, hydroxyethyl cellulose, polyethelene glycol and the like. Among these, methylcellulose is more desirably used.

In general, the compounding amount of the above-mentioned binder is desirably set to at least about 1 part by weight and at most about 10 parts by weight with respect to 100 parts by weight of the inorganic powder.

With respect to the above-mentioned plasticizer, not particularly limited, for example, glycerin and the like may be used.

Moreover, with respect to the lubricant, not particularly limited, for example, polyoxy alkylene-based compounds, such as polyoxyethylene alkyl ether, polyoxy propylene alkyl ether and the like may be used.

Specific examples of the lubricant include: polyoxyethylene monobutyl ether and polyoxypropylene monobutyl ether.

Here, the plasticizer and the lubricant are not necessarily contained in the mixed material powder depending on cases.

Upon preparing the wet mixture, a dispersant solution may be used, and with respect to the dispersant solution, examples thereof include: water, alcohol such as methanol, an organic solvent such as benzene, and the like.

Moreover, a molding auxiliary may be added to the wet mixture.

With respect to the molding auxiliary, not particularly limited, examples thereof include: ethylene glycol, dextrin, fatty acid, fatty acid soap, polyalcohol and the like.

Furthermore, a pore forming agent, such as balloons that are fine hollow spheres composed of oxide-based ceramics, spherical acrylic particles, graphite and the like may be added to the above-mentioned wet mixture, if necessary.

With respect to the above-mentioned balloons, not particularly limited, for example, alumina balloons, glass micro-balloons, shirasu balloons, fly ash balloons (FA balloons), mullite balloons and the like may be used. Among these, alumina balloons are more desirably used.

Here, with respect to the wet mixture using silicon carbide powder, prepared as described above, the temperature thereof is desirably set to about 28° C. or less. When the temperature is about 28° C. or less, the organic binder tends not to be gelatinized.

Moreover, the rate of organic components in the wet mixture is desirably set to about 10% by weight or less, and the content of moisture is desirably set to at least about 8.0% by weight and at most about 20.0% by weight.

The wet mixture, thus prepared, is transported, and charged into an extrusion-molding machine.

The wet mixture transported by the transporting device and charged into the molding machine is then extrusion-molded into a honeycomb molded body having a predetermined shape.

Next, the resulting honeycomb molded body is dried by using a drying apparatus, such as a microwave drying apparatus, a hot-air drying apparatus, a dielectric drying apparatus, a reduced-pressure drying apparatus, a vacuum drying apparatus, a frozen drying apparatus and the like so that a dried honeycomb molded body is formed.

Here, cutting is carried out on the honeycomb molded body thus formed, by using a cutting machine to cut the two ends thereof so that a honeycomb molded body having a predetermined length is formed.

Next, a predetermined amount of plug material paste that forms plugs is filled into ends on the outlet side of a group of cells on the inlet side and ends on the inlet side of a group of cells on the outlet side, if necessary, so that predetermined cells are sealed. Upon sealing the cells, a mask for sealing the cells is made in contact with the end face (that is, the cut face after the cutting) of the honeycomb molded body so that only the cells to be sealed are filled with the plug material paste.

With respect to the plug material paste, although not particularly limited, those plug material pastes that allow the plugs manufactured through post processes to have a porosity of at least about 30% and at most about 75% are desirably used, and, for example, the same material as that of the wet mixture may be used.

The filling of the plug material paste can be carried out on demand, and when the plug material paste has been filled thereto, for example, the resulting honeycomb structure obtained through the post process is desirably used as a honeycomb filter, and in the case where no plug material paste has been filled thereto, for example, the honeycomb structure obtained through the post process is desirably used as a catalyst supporting body.

Next, the honeycomb molded body, which has the plug material paste filled therein, is transported to a degreasing furnace by using a degreasing furnace carrying-in device so as to be degreased.

The honeycomb molded body is carried in into the degreasing furnace by using the degreasing furnace carrying-in device face, and degreased under predetermined conditions (for example, at least about 200° C. and at most about 500° C.).

Next, the honeycomb molded body on which degreasing has been carried out is fired in a firing jig, and the resulting honeycomb fired body is cooled by using a cooling apparatus in which a transporting member for transporting the firing jig and a plurality of blowers so that it becomes possible to manufacture a honeycomb fired body (see FIGS. 4A and 4B) formed by a single fired body as a whole in which: a plurality of cells are longitudinally placed in parallel with one another with a cell wall therebetween, and either one of ends of the cells is sealed.

In the firing for the honeycomb molded body, the honeycomb molded body is housed in a firing jig, and firing thereof is carried out in this state. With respect to the firing jig, the firing jig, explained in the cooling apparatus for a fired body in accordance with the embodiment of the first aspect of the present invention, is desirably used.

Here, with respect to the firing conditions for the honeycomb molded body, those conditions conventionally used upon manufacturing a filter made from a porous ceramic material (for example, at least about 1400° C. and at most about 2300° C. for at least about 1 hour and at most about 10 hours) may be used.

Thereafter, the resulting honeycomb fired body is cooled in a fired body cooling in which a cooling apparatus provided with a transporting member for transporting the firing jig and a plurality of blowers is used. With respect to the cooling method in the present fired body cooling, the cooling method, explained in the cooling method for the ceramic fired body in accordance with the embodiment of the third aspect of the present invention, is desirably used.

Moreover, the cooling desirably cools ceramic fired body to at least about 20° C. and at most about 80° C. in at least about 30 minutes and at most about 120 minutes.

Furthermore, the cooling apparatus is desirably provided with a suction mechanism for sucking the internal area of the cooling apparatus, the plurality of blowers are desirably placed at both sides with respect to the transporting member, and the suction mechanism is desirably placed at the upper side with respect to the transporting member.

The cooling apparatus is desirably provided with a removing member for removing deposits adhering to the firing jig.

In the fired body cooling relating to the method for manufacturing a honeycomb structure in accordance with the embodiment of the fourth aspect of the present invention, the reasons for the above-mentioned arrangements to be desirably used have been explained in the cooling method of a ceramic fired body in accordance with the embodiment of the third aspect of the present invention; therefore, the description thereof is omitted.

Next, a sealing material paste to form a sealing material layer (adhesive layer) is applied onto side faces of the honeycomb fired body thus cooled with an even thickness to form a sealing material paste layer, and a piling up of another honeycomb fired body on this sealing material paste layer is successively repeated so that an aggregate of honeycomb fired bodies having a predetermined size is manufactured.

With respect to the sealing material paste, examples thereof include an inorganic binder, an organic binder and a material made from inorganic fibers and/or inorganic particles.

With respect to the inorganic binder, for example, silica sol, alumina sol and the like may be used. Each of these may be used alone or two or more kinds of these may be used in combination. Among the inorganic binders, silica sol is more desirably used.

With respect to the organic binder, examples thereof include polyvinyl alcohol, methyl cellulose, ethyl cellulose, carboxymethyl cellulose and the like. Each of these may be used alone or two or more kinds of these may be used in combination. Among the organic binders, carboxymethyl cellulose is more desirably used.

With respect to the inorganic fibers, examples thereof include ceramic fibers, such as silica-alumina, mullite, alumina, silica and the like. Each of these may be used alone or two or more kinds of these may be used in combination. Among the inorganic fibers, alumina fibers are more desirably used.

With respect to the inorganic particles, examples thereof include carbides and nitrides, and specific examples include inorganic powder or the like made from silicon carbide, silicon nitride and boron nitride. Each of these may be used alone, or two or more kinds of these may be used in combination. Among the inorganic particles, silicon carbide having superior thermal conductivity is desirably used.

Moreover, a pore forming agent, such as balloons that are fine hollow spheres composed of oxide-based ceramics, spherical acrylic particles, graphite and the like may be added to the above-mentioned sealing material paste, if necessary.

With respect to the above-mentioned balloons, not particularly limited, for example, alumina balloons, glass micro-balloons, shirasu balloons, fly ash balloons (FA balloons), mullite balloons and the like may be used. Among these, alumina balloons are more desirably used.

Next, this aggregate of honeycomb fired bodies is heated so that the sealing material paste layers are dried and solidified to form sealing material layers (adhesive layers).

Next, cutting is carried out on the aggregate of honeycomb fired bodies in which a plurality of honeycomb fired bodies have been bonded to one another by interposing sealing material layers (adhesive layers), by using a diamond cutter or the like so that a cylindrical honeycomb block is manufactured.

Then, a sealing material layer (coat layer) is formed on the peripheral portion of the honeycomb block by using the above-mentioned sealing material paste so that a honeycomb structure in which a sealing material layer (coat layer) is formed on the periphery of a cylindrical honeycomb block having a structure in which a plurality of honeycomb fired bodies are bonded to one another by interposing sealing material layers (adhesive layers) is manufactured.

Thereafter, a catalyst is supported on the honeycomb structure on demand. The supporting of the catalyst may be carried out on the honeycomb fired bodies prior to being formed into an aggregate.

In the case where a catalyst is supported thereon, an alumina film having a high specific surface area is desirably formed on the surface of the honeycomb structure, and a co-catalyst and a catalyst such as platinum are applied onto the surface of the alumina film.

With respect to the method for forming the alumina film on the surface of the honeycomb structure, for example, a method in which the honeycomb structure is impregnated with a solution of a metal compound containing aluminum such as Al(NO₃)₃ and then heated and a method in which the honeycomb structure is impregnated with a solution containing alumina powder and then heated, are proposed.

With respect to the method for applying a co-catalyst to the alumina film, for example, a method in which the honeycomb structure is impregnated with a solution of a metal compound containing a rare-earth element, such as Ce(NO₃)₃, and then heated is proposed.

With respect to the method for applying a catalyst to the alumina film, for example, a method in which the honeycomb structure is impregnated with a solution of diammine dinitro platinum nitric acid ([Pt(NH₃)₂(NO₂)₂]HNO₃, platinum concentration: about 4.53% by weight) and then heated is proposed.

Moreover, a catalyst may be applied through a method in which after the catalyst has been preliminarily applied to alumina particles, the honeycomb structure is impregnated with a solution containing the alumina powder bearing the catalyst applied thereto, and then heated.

Here, the above-mentioned method for manufacturing a honeycomb structure in accordance with the embodiment of the fourth aspect of the present invention relates to an aggregated honeycomb structure having a structure in which a plurality of honeycomb fired bodies are bound to one another by interposing sealing material layers (adhesive layers); however, the honeycomb structure to be manufactured by the method in accordance with the embodiment of the fourth aspect of the present invention may be an integral honeycomb structure in which a pillar-shaped honeycomb block is formed by one honeycomb fired body. Here, desirably, the integral honeycomb structure is mainly composed of a material such as cordierite and aluminum titanate.

Upon manufacturing such an integral honeycomb structure, first, a honeycomb molded body of this kind is formed by using the same method as the method for manufacturing an aggregated honeycomb structure except that the size of a honeycomb molded body to be molded through the extrusion-molding is greater than that of the aggregated honeycomb structure.

Next, in the same manner as the method for manufacturing the aggregated honeycomb structure, the honeycomb molded body is dried by using a drying apparatus, such as a microwave drying apparatus, a hot-air drying apparatus, a dielectric drying apparatus, a reduced-pressure drying apparatus, a vacuum drying apparatus, a frozen drying apparatus and the like.

Next, cutting is carried out on the dried honeycomb molded body, by using a cutting machine to cut the two ends thereof.

Next, a predetermined amount of plug material paste that forms plugs is filled into ends on the outlet side of a group of cells on the inlet side and ends on the inlet side of a group of cells on the outlet side so that predetermined cells are sealed.

Thereafter, in the same manner as the manufacturing method for the aggregated honeycomb structure, the degreasing and firing are carried out to manufacture a honeycomb block, and by forming a sealing material layer (coat layer), if necessary, an integral honeycomb structure can be manufactured. Moreover, a catalyst may also be supported on the integral honeycomb structure by using the same method.

With respect to the honeycomb structure, the foregoing explanation has been given mainly on a honeycomb filter that is used to collect particulates in exhaust gases; however, the honeycomb structure may also be desirably used as a catalyst supporting body (honeycomb catalyst) that converts exhaust gases.

In the method for manufacturing a honeycomb structure in accordance with the embodiment of the fourth aspect of the present invention as explained above, it becomes possible to manufacture a honeycomb structure by using highly efficient operations.

Moreover, upon manufacturing a honeycomb structure through the above-mentioned method in accordance with the embodiment of the fourth aspect of the present invention, since the cooling of the honeycomb fired body, which has been conventionally carried out through natural radiation, is carried out by using a predetermined cooling apparatus, a sequence of working can be carried out continuously and tends to be more effectively. Therefore, the method for manufacturing a honeycomb structure in accordance with the embodiment of the fourth aspect of the present invention also tends to improve the efficiency of the all manufacturing method.

The following description will discuss the method for manufacturing a honeycomb structure in accordance with the embodiment of the fifth aspect of the present invention.

In the method for manufacturing a honeycomb structure in accordance with the embodiment of the fifth aspect of the present invention, the same method as the method for manufacturing a honeycomb structure in accordance with the embodiment of the fourth aspect of the present invention can be used except for the firing and the cooling; therefore, with respect to the method for manufacturing a honeycomb structure in accordance with the embodiment of the fifth aspect of the present invention, the following description will mainly discuss the firing and the cooling.

In the method for manufacturing a honeycomb structure in accordance with the embodiment of the fifth aspect of the present invention, first, a honeycomb molded body in which either one of ends of the cells is sealed with a plug material paste on demand is formed by using the same method as the method for manufacturing a honeycomb structure in accordance with the embodiment of the fourth aspect of the present invention, and degreasing is carried out on the honeycomb molded body.

Next, a firing in which the honeycomb molded body is fired in the firing jig by using the firing furnace in which the transporting member for transporting the firing jig and the plurality of blowers are installed to form a honeycomb fired body and the cooling in which the honeycomb fired body is cooled are carried out. More specifically, the above-mentioned firing and cooling are desirably carried out by using the firing furnace in accordance with the embodiment of the second aspect of the present invention.

With respect to the firing conditions, in the same manner as in the method for manufacturing a honeycomb structure in accordance with the embodiment of the fourth aspect of the present invention, those conditions conventionally used upon manufacturing a filter made from a porous ceramic material (for example, at least about 1400° C. and at most about 2300° C. for at least about 1 hour and at most about 10 hours) may be used.

Moreover, in the above-mentioned cooling, the cooling desirably cools honeycomb fired body to at least about 20° C. and at most about 80° C. in at least about 30 minutes and at most about 120 minutes.

The reasons for the above-mentioned arrangements to be desirably used have been explained in the cooling method of a ceramic fired body in accordance with the embodiment of the third aspect of the present invention; therefore, the description thereof is omitted.

Furthermore, in the embodiment of the fifth aspect of the present invention, the cooling apparatus is desirably provided with a suction mechanism for sucking the internal area of cooling apparatus, the plurality of blowers are desirably placed at both sides with respect to the transporting member, and the suction mechanism is desirably placed at the upper side with respect to the transporting member.

The cooling apparatus is desirably provided with a removing member for removing deposits adhering to the firing jig.

After the honeycomb molded body has been fired and formed into a honeycomb fired body cooled to a predetermined temperature, an aggregate of the honeycomb fired bodies is formed and a honeycomb block is then manufactured by using the same manufacturing method as that of the honeycomb structure in accordance with the embodiment of the fourth aspect of the present invention so that a honeycomb structure is manufactured by further forming a sealing material layer (coat layer) thereon.

In the method for manufacturing the honeycomb structure in accordance with the embodiment of the fifth aspect of the present invention also, a catalyst may be supported on a honeycomb structure, if necessary, in the same manner as in the method for manufacturing the honeycomb structure in accordance with the embodiment of the fourth aspect of the present invention.

In the method for manufacturing the honeycomb structure in accordance with the embodiment of the fifth aspect of the present invention also, an integral honeycomb molded body is formed by using the same method as method for manufacturing the honeycomb structure in accordance with the embodiment of the fourth aspect of the present invention, that is, the method for manufacturing an aggregated honeycomb structure, except that the size of a honeycomb molded body to be molded through extrusion-molding is greater than that of the aggregated honeycomb structure.

With respect to the honeycomb structure, the foregoing explanation has been given mainly on a honeycomb filter that is used to collect particulates in exhaust gases; however, the honeycomb structure may also be desirably used as a catalyst supporting body (honeycomb catalyst) that converts exhaust gases.

In the method for manufacturing a honeycomb structure in accordance with the embodiment of the fifth aspect of the present invention as explained above, it may become easier to manufacture a honeycomb structure by using highly efficient operations.

Moreover, upon manufacturing a honeycomb structure through the above-mentioned method for manufacturing a honeycomb structure in accordance with the embodiment of the fifth aspect of the present invention, since the firing and the cooling are carried out in the single firing furnace, a sequence of working can be carried out continuously and tends to be carried out more effectively. Therefore, the method for manufacturing a honeycomb structure in accordance with the embodiment of the fifth aspect of the present invention also tends to improve the efficiency of the entire manufacturing method.

### EXAMPLES

By way of specific examples, the present invention will be explained hereinafter in detail. However, the present invention is not limited only by these examples.

In these examples, upon manufacturing honeycomb fired bodies, the honeycomb fired bodies were cooled under various cooling conditions so that the time required for cooling and changes in the honeycomb fired body after the cooling were examined.

### Example 1

Powder of α-type silicon carbide having an average particle diameter of 10 μm (250 kg), powder of α-type silicon carbide having an average particle diameter of 0.5 μm (100 kg) and an organic binder (methylcellulose) (20 kg) were mixed to prepare mixed powder.

Next, separately, a lubricant (UNILUB, made by NOF Corporation) (12 kg), a plasticizer (glycerin) (5 kg) and water (65 kg) were mixed to prepare a liquid mixture, and this liquid mixture and the mixed powder were mixed by using a wet-type mixing machine so that a wet mixture was prepared.

The moisture content of the wet mixture thus prepared was 14% by weight.

Next, this wet mixture was transported to an extrusion-molding machine by using a transporting device, and charged into a material charging port of the extrusion-molding machine.

Here, the moisture content of the wet mixture immediately before the charging into the extrusion-molding machine was 13.5% by weight.

The wet mixture was then extrusion-molded into a raw molded body having a shape shown in FIGS. 4A and 4B. This raw molded body is in a state that its end portions of cells were not sealed.

Next, after the raw molded body had been dried by using a microwave drying apparatus or the like, a plug material paste having the same composition as that of the wet mixture was filled into predetermined cells.

The honeycomb molded body to which the plug material paste had been filled was again dried by using a drying apparatus, and the honeycomb molded body thus dried was carried in a degreasing furnace. The honeycomb molded body, carried in the degreasing furnace, was degreased at 400° C.

Thereafter, by using the firing furnace 20 (continuous firing furnace) of the second aspect of the present invention shown in FIG. 2B, firing was carried out on the degreased honeycomb molded body, and the resulting honeycomb fired body was cooled in the cooling process.

More specifically, the honeycomb molded body, mounted on the firing jig, was put into a continuous firing furnace where it was fired at 2200° C. in a normal-pressure argon atmosphere serving as an inert gas for 3 hours.

Successively, a cooling apparatus 30 for a fired body having a structure shown in FIG. 1 was installed next to the carrying-out port of the continuous firing furnace, and cooling was carried out on the honeycomb fired body under conditions as shown in Table 1.

After the cooling, the honeycomb fired body, which was a silicon carbide sintered body, had a porosity of 40%, an average pore diameter of 12.5 μm, a size of 34.3 mm×34.3 mm×150 mm, the number of cells (cell density) of 46.5 pcs/cm² and a thickness of each cell wall of 0.20 mm.

### Examples 2 to 5

The same processes as in Example 1 were carried out except that the cooling conditions in the cooling process were set to values shown in Table 1 to manufacture a honeycomb fired body.

### Reference Examples 1 and 2

The same processes as in Example 1 were carried out except that the cooling conditions in the cooling process were set to values shown in Table 1 to carry out a swift cooling treatment so that a honeycomb fired body was manufactured.

### Comparative Example 1

The same processes as in Example 1 were carried out except that the cooling process was carried out through natural radiation, without carrying out the cooling process by the cooling apparatus for a fired body, so that a honeycomb fired body was manufactured.

### (Observation on State of Honeycomb Fired Body)

### Breaking Test

Referring to JIS R 1601, four-points bending tests were carried out under conditions of an upper-face span-to-span distance of 20 mm, a lower-face span-to-span distance of 133 mm, a speed of 10 mm/min and an applied load of 2940 N(300 kgf) by using an Instron 5582 so that the honeycomb fired body was observed as to whether or not there were any damages. Here, the number of the test pieces was set to ten.

The results are as shown in Table 1.

Here, the applied load is an experience value of which a normal honeycomb fired body is not destroyed but a honeycomb fired body having defects such as cracks and the like is destroyed.

The contents of JIS R 1601 are incorporated herein by reference in its entirety.

TABLE 1

| | Number of | | | Speed of | | Temperature | Presence or |
|---|---|---|---|---|---|---|---|
| | blowers (one | Number of | Flow rate of | conveyor | Cooling | after cooling | absence of fracture |
| | side) | blowers (total) | blowers [m³/h] | [m/min] | time [min] | [min] | upon breaking test |
| Example 1 | 3 | 6 | 30000 | 0.20 | 60 | 40 | Not present |
| Example 2 | 3 | 6 | 40000 | 0.20 | 60 | 30 | Not present |
| Example 3 | 3 | 6 | 35000 | 0.30 | 40 | 40 | Not present |
| Example 4 | 3 | 6 | 20000 | 0.15 | 80 | 40 | Not present |
| Example 5 | 3 | 6 | 10000 | 0.12 | 100 | 40 | Not present |
| Reference | 3 | 6 | 50000 | 0.40 | 30 | 30 | Present |
| Example 1 | | | | | | | |
| Reference | 3 | 6 | 50000 | 0.48 | 25 | 40 | Present |
| Example 2 | | | | | | | |

| | | | | |
|---|---|---|---|---|
| Comparative | Natural radiation | 150 | 40 | Not present |
| Example 1 | | | | |

As clearly indicated by the results shown in Table 1, under the cooling conditions in Examples 1 to 5, the honeycomb fired body can be cooled to 30 to 40° C. in 40 to 100 minutes and the cooled honeycomb fired body was not broken even under the breaking test; thus, it can be said that an efficient cooling was carried out under the cooling conditions in Examples 1 to 5.

In contrast, in the case of the honeycomb fired body in Comparative Example 1, although the state of the honeycomb fired body after the cooling was desirable without any fracture in the breaking test, it took 150 min to cool the honeycomb fired body to the same temperature as in Example 1, resulting in the necessity of a cooling time of a great degree in comparison with the examples.

Moreover, in the case of Reference Examples 1 and 2, although the honeycomb fired body was cooled to 30 to 40° C. in a short period of time such as 25 to 30 minutes, the honeycomb fired bodies were partially damaged at the time of the breaking test. Presumably, this is because of an influence of a thermal impact due to the swift cooling.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A cooling apparatus for a fired body, comprising:
a transporting member for transporting a firing jig in which a ceramic fired body is housed;
a plurality of blowers for cooling said ceramic fired body; and
a suction mechanism for changing the atmosphere inside said firing jig from an inert gas atmosphere to an air atmosphere.

2. The cooling apparatus for a fired body according to claim 1,
wherein
said plurality of blowers are placed at both sides with respect to said transporting member.

3. The cooling apparatus for a fired body according to claim 1,
wherein
said suction mechanism is placed at an upper side with respect to said transporting member.

4. The cooling apparatus for a fired body according to claim 1, further comprising:
a removing member for removing deposits adhering to said firing jig.

5. The cooling apparatus for a fired body according to claim 1, which is installed in a firing furnace, or next to a carrying-out port of a firing furnace.

6. A firing furnace comprising:
a transporting member for transporting a firing jig in which a ceramic molded body is housed from a carrying-in port toward a carrying-out port;
a heating unit for heating said ceramic molded body; and
the cooling apparatus for a fired body disclosed in claim 1,
said cooling apparatus disposed such that a distance between said cooling apparatus and said carrying-out port is smaller than a distance between said heating unit and said carrying-out port.

7. The firing furnace according to claim 6,
wherein
said plurality of blowers are placed at both sides with respect to said transporting member in said cooling apparatus for a fired body.

8. A cooling method of a ceramic fired body, comprising: cooling a firing jig with a ceramic fired body housed in by using a cooling apparatus including a transporting member for transporting said firing jig,
wherein
said cooling apparatus further comprises a plurality of blowers, and
ceramic fired body which is housed inside the firing jig placed on said transporting member is cooled by said blowers.

9. The cooling method of a ceramic fired body according to claim 8,
wherein
said ceramic fired body is cooled to at least about 20° C. and at most about 80° C. in at least about 30 minutes and at most about 120 minutes.

10. The cooling method of a ceramic fired body according to claim 8,
wherein
said cooling apparatus further comprises a suction mechanism for sucking the internal area of the cooling apparatus.

11. The cooling method of a ceramic fired body according to claim 10,
wherein
said suction mechanism is placed at an upper side with respect to said transporting member.

12. The cooling method of a ceramic fired body according to claim 8,
wherein
said blowers at one of the sides and said blowers at the other side are placed face to face with each other.

13. The cooling method of a ceramic fired body according to claim 8,
wherein
said cooling apparatus further comprises a removing member for removing deposits adhering to said firing jig.

14. A method for manufacturing a honeycomb structure, comprising:
manufacturing a pillar-shaped honeycomb molded body having a large number of cells longitudinally placed in parallel with one another with a cell wall therebetween, by molding a ceramic raw material; and
firing said honeycomb molded body in a firing jig to manufacture a honeycomb structure comprising a honeycomb fired body, and further comprising:
preparing a cooling apparatus comprising a transporting member for transporting said firing jig; and a plurality of blowers; and
cooling the honeycomb fired body by using said cooling apparatus after said firing of said honeycomb molded body inside the firing jig.

15. The method for manufacturing a honeycomb structure according to claim 14,
wherein
said cooling cools said honeycomb fired body to at least about 20° C. and at most about 80° C. in at least about 30 minutes and at most about 120 minutes.

16. The method for manufacturing a honeycomb structure according to claim 14,
wherein
said cooling apparatus further comprises a suction mechanism for sucking the internal area of the cooling apparatus.

17. The method for manufacturing a honeycomb structure according to claim 16,
wherein
said suction mechanism is placed at an upper side with respect to said transporting member.

18. The method for manufacturing a honeycomb structure according to claim 14,
Wherein
said plurality of blowers are placed at both sides with respect to said transporting member.

19. The method for manufacturing a honeycomb structure according to claim 14,
wherein
said cooling apparatus further comprises a removing member for removing deposits adhering to said firing jig.

20. A method for manufacturing a honeycomb structure, comprising:
manufacturing a pillar-shaped honeycomb molded body having a large number of cells longitudinally placed in parallel with one another with a cell wall therebetween, by molding a ceramic raw material; and
firing said honeycomb molded body in a firing jig by using a firing furnace to manufacture a honeycomb structure comprising a honeycomb fired body, and further comprising:
preparing a firing furnace comprising a cooling apparatus comprising a transporting member for transporting said firing jig; and a plurality of blowers;
firing said honeycomb molded body in said firing jig to manufacture said honeycomb fired body; and
cooling of said honeycomb fired body, said firing and said cooling are carried out in said firing furnace.

21. The method for manufacturing a honeycomb structure according to claim 20,
wherein
said cooling cools said honeycomb fired body to at least about 20° C. and at most about 80° C. in at least about 30 minutes and at most about 120 minutes.

22. The method for manufacturing a honeycomb structure according to claim 20,
wherein
said cooling apparatus further comprises a suction mechanism for sucking the internal area of the cooling apparatus.

23. The method for manufacturing a honeycomb structure according to claim 22,
wherein
said suction mechanism is placed at an upper side with respect to said transporting member.

24. The method for manufacturing a honeycomb structure according to claim 20,
wherein
said plurality of blowers are placed at both sides with respect to said transporting member.

25. The method for manufacturing a honeycomb structure according to claim 20,
wherein
said cooling apparatus further comprises a removing member for removing deposits adhering to said firing jig.
